(19) United States
(12) Patent Application Publication
(10) Pub. No.: US 2024/0385839 A1
(43) Pub. Date: Nov. 21, 2024

(54) PROCESSING METHOD OF MIXED PRECISION OPERATION AND INSTRUCTION PROCESSING APPARATUS

(71) Applicant: Alibaba Innovation Private Limited, Singapore (SG)

(72) Inventor: Wenmeng ZHANG, Hangzhou (CN)

(21) Appl. No.: 18/665,108

(22) Filed: May 15, 2024

(30) Foreign Application Priority Data
May 17, 2023 (CN) 202310571408.3

(51) Int. Cl. G06F 9/30

(52) U.S. Cl. CPC G06F 9/30145; G06F 9/30014

(57) ABSTRACT

The disclosed embodiments of the present disclosure provide a processing method of mixed precision operation and an instruction processing apparatus. The instruction processing apparatus includes: a register file comprising a plurality of registers; an execution unit; and a decoding unit configured to decode a mixed precision operation instruction and acquire decoding information, the decoding information indicating the execution unit to execute following operations: executing appointed arithmetic operation on a first register and a second register of the plurality of registers, and writing an operation result back to a third register of the plurality of registers, precisions of operands of the first register and the second register being different; wherein the execution unit is coupled with the register file and the decoding unit and is configured to execute an operation corresponding to the decoding information. Compared with an existing processor, the instruction processing apparatus does not need to unify mixed precision into the same precision for arithmetic operation, thus improving the processing efficiency of the mixed precision.

### CROSS-REFERENCE TO RELATED APPLICATIONS

The disclosure claims the benefits of priority to Chinese Application No. 202310571408.3, filed on 17 May 2023, which is incorporated herein by reference in its entirety.

### TECHNICAL FIELD

The present disclosure relates to the technical field of processors, and more specifically relates to a processing method of mixed precision operation and an instruction processing apparatus.

### BACKGROUND

With the development of reduced instruction sets, the industry has developed novel processor architectures based on the reduced instruction sets. RISC-V is an open-source instruction set architecture based on the principle of reduced instruction set, which not only has the advantages of complete open source, simple architecture and modular design, but also makes the hardware implementation simple by defining the architecture, which can reduce the development cycle and cost of processor chips.

In the field of neural networks, model quantization refers to the conversion of operational data (weights and input data) in a neural network model from a high-precision type to a low-precision type, such as from a 32-bit single-precision floating-point number to an 8-bit integer data, and then computed. Model quantization helps to improve the efficiency of model training and reasoning, but it may affect the model accuracy. As a result, some models adopt a compromise quantization approach: a part of the operational data is converted from the high-precision type to the low-precision type, while the other part remains unchanged in precision, and the model subjected to this quantization method will be referred to below as a mixed precision model. Therefore, when a processor executes the mixed precision model, it needs to process a large number of mixed precision operations, for example, processing the multiplication of 16-bit half-precision floating-point numbers and 8-bit integer data. But, because the instruction set architecture used by some processors (for example, RISC-V) does not provide standard instructions suitable for the mixed precision operations, it is necessary to use the standard instructions of the same precision operation for processing. That is, each operand needs to be unified to the same precision, and then the standard instructions of the same precision operation are used for processing. However, this processing mode may reduce the execution efficiency of the mixed precision model.

### SUMMARY

In view of this, the disclosed embodiments of the present disclosure provide a processing method of mixed precision operation and an instruction processing apparatus.

Some embodiments of the present disclosure provide an instruction processing apparatus, including: a register file including a plurality of registers; a decoding unit including circuitry configured to decode a mixed precision operation instruction and to acquire decoding information, the decoding information indicating an execution unit to execute following operations; and an execution unit communicatively coupled to the register file and decoding unit and includes circuitry configured to acquire the decoding information from the decoding unit for executing operations including: executing appointed arithmetic operation on a first register and a second register of the plurality of registers, and writing an operation result back to a third register of the plurality of registers, precisions of operands of the first register and the second register being different.

In some embodiments, the mixed precision operation instruction includes an operation code and at least one operand; and the at least one operand is used for indicating at least one of the first register, the second register and the third register.

In some embodiments, when the at least one operand does not indicate the first register, the second register and the third register completely, the decoding unit determines the register which is not indicated in the at least one operand, and adds a corresponding register identifier into the decoding information.

In some embodiments, the appointed arithmetic operation is multiplication, addition, subtraction or division.

In some embodiments, when the appointed arithmetic operation is multiply accumulation, the decoding unit indicates the execution unit to execute the following operations: multiplying the first register and the second register, adding the multiplication result to the third register, and writing the addition result back to the third register.

In some embodiments, the precision indicated by the third register is the same as the higher precision in operands in the first register and the second register, or higher than the higher precision in the operands in the first register and the second register.

In some embodiments, the first register is an 8-bit integer register, and the second register is an 8, 16, 19, 32 or 64-bit floating-point register.

In some embodiments, an instruction set architecture of the instruction processing apparatus is an RISC-V instruction set architecture.

In some embodiments, the mixed precision operation instruction is an extended instruction of the RISC-V instruction set architecture.

Some embodiments of the present disclosure provide a processing method of mixed precision operation, including: reading a first operand to a first register from a first memory address; reading a second operand to a second register from a second memory address; executing appointed arithmetic operation on the first register and the second register, and storing an operation result to a third register; and storing the operation result in the third register to a third memory address, the first operand and the second operand being different precision values.

In some embodiments, the precision indicated by the third register is the same as the higher precision in operands in the first register and the second register, or higher than the higher precision in the operands in the first register and the second register.

In some embodiments, each step of the processing method corresponds to an assembly instruction.

Some embodiments of the present disclosure provide a processing method of mixed precision operation.

Some embodiments of the present disclosure provide a computer system, including: a memory; and one or more processors communicatively coupled with the memory, the memory storing a set of instructions that are executable by one or more processors of the computer system to cause the computer system to perform operations corresponding to any one of the processing methods as described above.

Some embodiments of the present disclosure provides a non-transitory computer readable medium, storing a set of instructions that are executable by one or more processors of a device to cause the device to perform operations corresponding to the method according to any one of the processing methods as described above.

### BRIEF DESCRIPTION OF THE DRAWINGS

The accompanying drawings described herein are used for providing a further understanding of this disclosure, and form part of this disclosure. Exemplary embodiments of this disclosure and descriptions thereof are used for explaining this disclosure, and do not constitute any inappropriate limitation to this disclosure. It should be noted that according to industry standard practices, various structures are not drawn to scale. In fact, for clear discussion, the sizes of various structures may be increased or reduced arbitrarily. In the accompanying drawings:

FIG. 1 is a schematic diagram of an exemplary convolutional neural network model, according to some embodiments of the present disclosure.

FIG. 2 is a schematic block diagram of an exemplary processor according to some embodiments of the present disclosure.

FIG. 3 is a schematic block diagram of an exemplary instruction processing apparatus according to some embodiments of the present disclosure.

FIG. 4A is a flowchart of an exemplary processing method of mixed precision operation, according to some embodiments of the present disclosure.

FIG. 4B is a flowchart of an exemplary processing method of mixed precision operation, according to some embodiments of the present disclosure.

FIG. 5 is a structural schematic diagram of an exemplary processing system according to some embodiments of the present disclosure.

FIG. 6 is a structural schematic diagram of an exemplary processing system, according to some embodiments of the present disclosure.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the present disclosure. Instead, they are merely examples of apparatuses and methods consistent with aspects related to the present disclosure as recited in the appended claims. Particular aspects of the present disclosure are described in greater detail below. The terms and definitions provided herein control, if in conflict with terms or definitions incorporated by reference.

In some embodiments of the present disclosure, an instruction processing apparatus for mixed precision operation is provided. This apparatus is capable of accepting operands with varying precisions for arithmetic operations. It avoids the conventional approach of unifying mixed precisions into a single precision before conducting arithmetic operations. By doing so, it enhances the efficiency of mixed precision operation and saves storage space that would have been required for unification of mixed precisions. This apparatus is ideal for executing mixed precision models, thereby optimizing the efficiency of model training and reasoning.

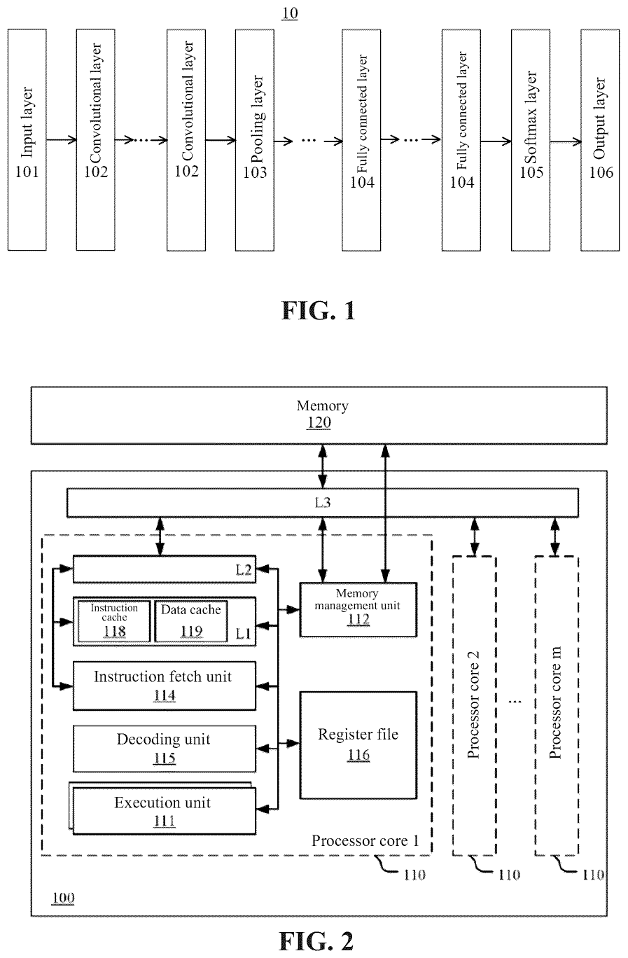

FIG. 1 is a schematic diagram of an exemplary convolutional neural network model 10, according to some embodiments of the present disclosure. As shown in FIG. 1, convolutional neural network model 10 includes an input layer 101, a plurality of convolutional layers 102, a plurality of pooling layers 103, a plurality of fully connected layers 104, a classification layer 105 and an output layer 106. In some embodiments, three convolutional layers 102 and one pooling layer 103 may form a module, which can repeatedly occur n times in the convolutional neural network model, and n is a positive integer. Convolutional layers 102 can provide convolution computation, and the convolution computation is similar to matrix computation. For example, inputted matrixes and convolution kernels are subjected to matrix multiplication and summation computation in sequence to obtain an output for the next layer. Pooling layers 103 are configured to add the inputted matrixes to obtain an average (average pooling) or a maximum value (maximum pooling) of the value of a feature map. Fully connected layers 104 reassembles the inputted matrix data representing local features into a complete matrix representing all the features through a weight matrix. Because all local features are used in fully connected layers 104, it is called fully connected. Classification layer 105 is configured to, in a classification process, map the outputs of the plurality of neurons into a [0,1] interval through an activation function (such as softmax), and take the obtained values as probabilities for classification and identification. In these layers, except the pooling layers without the weight parameters, other layers have relative weight parameters. The model quantization can be implemented to convert the weight parameters or the input data in the model from high-precision data to low-precision data. The quantization operation on the weight parameters can be introduced by taking one convolution computation as an example.

It is assumed that the input of a convolution layer is a matrix X, including elements x1 to x9, and a convolution kernel is Y, including elements w1 to w4, as shown below:

$$X = [ \begin{matrix}x 1 & x 2 & x 3 \\ x 4 & x 5 & x 6 \\ x 7 & x 8 & x 9\end{matrix} ] ; Y = [ \begin{matrix}w 1 & w 2 \\ w 3 & w 4\end{matrix} ] \qquad ( 1 )$$

The output of the convolution layer is defined as a matrix Z, and the elements z1 to z4 of the output matrix Z are respectively represented based on:

$$z 1 = x 1 w 1 + x 2 w 3 , z 2 = z 1 w 2 + z 2 w 4 , z 3 = z 3 w 1 + z 4 w 3 , and z 4 = z 3 w 2 + z 4 w 4 \qquad ( 2 )$$

The convolution layer is responsible for matrix summation computation. Through the convolution layer, the features of the input data can be extracted and the data scale can be compressed at the same time. Each element in the convolution kernel Y is the weight parameter of the model. Generally, the convolution neural network model has a plurality of convolution layers, a plurality of fully connected layers, classification layers, etc., and these layers all have relative weight parameters. It can be known that the data scale of the weight parameters is very large, and the data scale of the input data such as images is also very large. Therefore, although the weight parameters and the input data with high precision help to improve the model precision, the model needs enough storage space and high data throughput during training and reasoning.

In face of this, the weight parameters or input data can be converted from higher precision data to lower precision data for storage and computation through model quantization, for example, 32-bit floating point data can be converted into 8-bit integers (signed integers or unsigned integers) or 16-bit floating point data for storage and computation, so that the storage space can be saved, and the computation efficiency can be improved.

Correspondingly, the mixed precision model can be that a part of weight parameters or input data in the model are converted from a high precision type to a lower precision type, and the other part of weight parameters or input data in the model can keep the precision unchanged. For example, the weight parameters of some convolutional layers can be converted from high precision to lower precision, and the other data can keep the precision unchanged. There are many methods for converting high-precision data into lower-precision data, which are not introduced in detail herein.

FIG. 2 is a schematic block diagram of an exemplary processor 100 according to some embodiments of the present disclosure. As shown in FIG. 2, processor 100 includes one or more processor cores 110 for processing instructions. An application program or a system platform may control processor cores 110 to process and execute the instructions.

Each processor core 110 may be of a specific instruction set architecture. In some embodiments, the specific instruction set architecture can be any one of: a CISC (Complex Instruction Set Computing) architecture, a RISC (Reduced Instruction Set Computing) architecture, a VLIW (Very Long Instruction Word) architecture, or a combined architecture of the instruction sets above, or any special instruction set architecture. Different processor cores 110 may be respectively provided with the same or different instruction set architectures. For example, processor cores 110 are provided with RISC-V architectures. In some embodiments, processor cores 110 may also include other processing modules, such as a DSP (Digital Signal Processor), and a neural network processor.

Processor 100 may further include a multi-level storage structure, such as a register file 116, multi-level caches L1-L3, and a storage 120 (denoted as memory 120 in FIG. 2) accessed through a storage bus.

Register file 116 may include a plurality of registers configured to store different types of data or instructions, and the registers may be of different types. For example, register file 116 may include: an integer register, a floating-point register, a status register, an instruction register, a pointer register, and the like. The registers in register file 116 may be implemented by using general-purpose registers, or may adopt a specific design according to actual requirements of processor 100.

Caches L1-L3 may be completely or partially integrated in each processor core 110. For example, first-level cache L1 can be located in each processor core 110 and includes an instruction cache 118 for storing instructions and a data cache 119 for storing data. According to different processor architectures, in some embodiments, at least one level of cache (for example, third-level cache L3 shown in FIG. 2) may be located outside the plurality of processor cores 110 and shared by the processor cores. Processor 100 may further include an external cache.

Processor 100 may include a Memory Management Unit (MMU) 112, which includes circuitry that is configured to implement translation from a virtual address to a physical address. A part of mapping relation from the virtual address to the physical address is cached in MMU 112, and MMU 112 may also acquire the mapping relation which is not cached from a memory. One or more MMUs 112 may be arranged in each processor core 110, and MMUs 112 in different processor cores 110 may also be synchronized with MMUs 112 located in other processors or processor cores, so that all the processors or the processor cores may share a unified virtual storage system.

Processor 100 is configured to execute an instruction sequence (namely an application program). Processor 100 executes each instruction according to the instruction set architecture and an instruction flow. Generally, the process of executing each instruction includes the steps of: fetching the instruction from a storage for storing the instruction, decoding the fetched instruction, executing the decoded instruction, storing an instruction execution result and the like. In some embodiments, the steps can be repeated until all the instructions in the instruction sequence are executed or a shutdown instruction is met.

In order to realize instruction processing, processor 100 includes an instruction fetch unit 114, a decoding unit 115, and an execution unit 111.

Instruction fetch unit 114 serves as a starting engine of processor 100 and includes circuitry that is configured to migrate the instruction from instruction cache 118 or memory 120 to the instruction register (for example, a register used for storing the instruction in register file 116), and receive a next instruction fetch address or compute and obtain the next instruction fetch address according to an instruction fetch algorithm. The instruction fetch algorithm may include incrementing an address or decrementing an address according to the length of the instruction, for example.

After the instruction is fetched, processor 100 enters an instruction decoding stage. At this stage, decoding unit 115 can use circuitry to interpret and decode the retrieved instruction according to a predetermined instruction format, so as to distinguish different instruction categories and operand acquisition information (the operand acquisition information may point to an immediate number or a register for storing an operand), thus preparing for operation of execution unit 111.

For different types of instructions, a plurality of different execution units 111 may be correspondingly arranged in processor 100. Execution units 111 may be an arithmetic operation unit (such as a multiplication circuit, a division circuit, an addition circuit, a subtraction circuit, various logic circuits or a combination circuit thereof), a memory execution unit (configured to, for example, access the memory according to an instruction to read data in the memory or write appointed data into the memory), various coprocessors and the like. In processor 100, the plurality of execution units may run in parallel and output corresponding execution results.

In some embodiments, processor 100 is a multi-core processor and includes a plurality of processor cores 110 sharing a third-level cache L3, and the processors 2-m may have the same or different structures as the processor core 1. In some embodiments, processor 100 may be a single-core processor, or a logic element for processing instructions in an electronic system. The present disclosure is not intended to be specified to any specific type of processor.

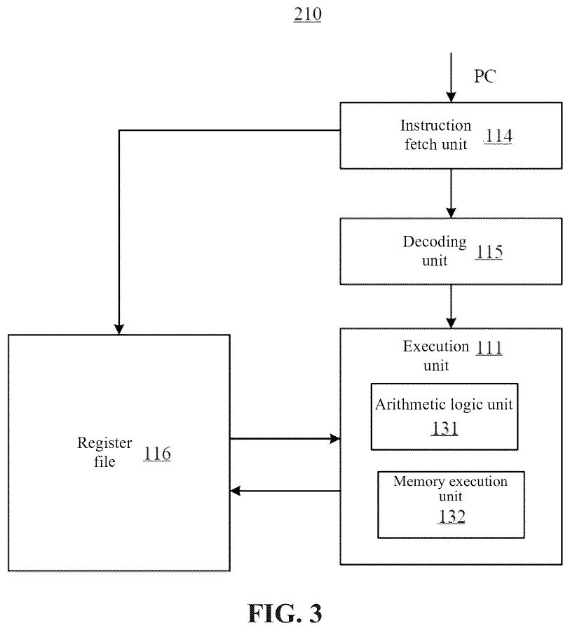

FIG. 3 is a schematic block diagram of an exemplary instruction processing apparatus 210 according to some embodiments of the present disclosure. In order to be clear, only units related to instruction processing are shown in FIG. 3.

Instruction processing apparatus 210 may include but is not limited to a processor, a processor core of a multi-core processor, or a processing element in an electronic system. In some embodiments, instruction processing apparatus 210 can be the processor core of processor 100 shown in FIG. 2, and the units or modules the same as those in FIG. 2 adopt accompanying drawings marks the same as those in FIG. 2.

When an application program runs on instruction processing apparatus 210, the application program is compiled into an instruction sequence including a plurality of instructions. A program counter PC is configured to indicate an instruction address of an instruction to be executed. Instruction fetch unit 114 acquires the instruction from instruction cache 118 in first-level cache L1 or memory 120 outside instruction processing apparatus 210 according to a value of the program counter PC.

Instruction processing apparatus 210 can be provided with a CISC architecture, a RISC architecture, a VLIW architecture, or a combined architecture of the instruction sets above, or any special instruction set architecture. For example, instruction processing apparatus 210 is provided with an RISC-V instruction set architecture. According to conventional technology, instruction processing apparatus 210 only includes a standard instruction of the specific instruction set architecture. Therefore, for the mixed precision operation, operands need to be unified to be at the same precision, and then the standard instruction of the same precision operation can be utilized for processing. Taking mixed precision multiplication as an example, operation corresponding to an instruction sequence processed by instruction processing apparatus 210 is shown in Table 1.

TABLE 1

| | |
|---|---|
| 1 | Apply for a temporary interval B |
| 2 | Use a read data instruction to read int8 data in A to a register |
| 3 | Use a data conversion instruction to |
| | convert int8 in the register to float16 |
| 4 | Use a data write instruction to store the float16 in an interval B |
| 5 | Read the float16 data from B to the register |
| 6 | Read float16 data from C to the register |
| 7 | Use a float16 multiplying float16 |
| | instruction to compute the float16 result |
| 8 | Store the float16 result in an interval D |

According to some embodiments of the present disclosure, instruction processing apparatus 210 not only includes the standard instruction of the specific instruction set architecture, but also includes an extension instruction for mixed precision operation, and the extension instruction is called as a mixed precision operation instruction hereinafter. Still taking mixed precision multiplication as an example, the operation corresponding to the instruction sequence is shown in Table 2.

TABLE 2

| | |
|---|---|
| 1 | Read int8 data in an address A to the register |
| 2 | Read the float16 data in an address C to the register |
| 3 | Use an int8 multiplying float16 instruction to compute the |
| | float16 result and put it in the register |
| 4 | Store the float16 result in an interval D |

As shown in Tables 1 and 2, the processor including the mixed precision operation instructions may complete the mixed precision operation through fewer instructions, so that the performance of the mixed precision operation is improved. When compared with the conventional technology, the occupation of storage space can be reduced because temporary space is not required to be applied.

The execution process of instruction processing apparatus 210 on mixed precision multiplication is introduced in detail according to FIG. 3. Instruction processing apparatus 210 sequentially acquires and executes each instruction according to the value of a program counter PC. The program counter PC is a register for storing the instruction address of the next instruction. The processor acquires and executes the instruction from the memory or the cache according to the address indicated by the program counter PC.

Firstly, instruction fetch unit 114 acquires an instruction 1 from the address A of instruction cache 118; decoding unit 115 identifies the instruction 1 to obtain that the instruction 1 is a data loading instruction and provides the data loading instruction to a memory execution unit 132 in execution unit 111; and memory execution unit 132 loads int8 data in the address A to a register rs1. Then, instruction fetch unit 114 acquires an instruction 2 from instruction cache 118; decoding unit 115 identifies the instruction 2, identifies that the instruction 2 is the data loading instruction and provides the data loading instruction to memory execution unit 132 in execution unit 111; and memory execution unit 132 loads float16 data in the address B to a register rs2. The register rs1 may be an integer register or a floating point register, and the register rs2 may be a floating point register. Then, instruction fetch unit 114 acquires an instruction 3 from instruction cache 118; decoding unit 115 decodes the instruction 3, identifies that the instruction 3 is multiplication, determines registers rs1 and rs2 for storing two operands and a register rs for storing a result, and provides decoding information to an arithmetic logic unit 131 in execution unit 111; and the arithmetic logic unit 131 multiplies the register rs1 by the register rs2 and stores the result in the register rs. Finally, instruction fetch unit 114 acquires an instruction 4 from instruction cache 118; decoding unit 115 identifies the instruction 4, identifies that the instruction 4 is a data storage instruction and provides the data storage instruction to memory execution unit 132 in execution unit 111; and data in the register rs is stored on an address D.

In some embodiments, the instruction form of the mixed precision operation is, for example, the following form:

$$op rs , rs 1 , rs 2 ; \qquad ( 3 )$$

where, op represents an instruction of the mixed precision operation, it may be multiplication, division, addition, subtraction or multiply accumulation. rs1 and rs2 indicate a first register and a second register respectively which are correspondingly configured to store operands with different precisions respectively. rs is a third register and represents that the result is stored in the register rs. Generally, the precision of the operands is matched with the bit width and the type of the register, for example, int8 and float16 data adopt an 8-bit integer register and a 16-bit floating-point register respectively. The present disclosure is not so limited, any corresponding register capable of storing the provided operands can be used. For example, although an 8-bit floating-point register is generally used for the operand of fp8, an 8-bit, 16-bit, 19-bit (generally storing the number of floating points in a TF32 format), a 32-bit, 64-bit, 128-bit or 512-bit floating-point register may also be used. In some embodiments, although an 8-bit floating-point register is generally used for the operand of int8, a 16-bit or 32-bit floating-point register may also be used. The rs stores an arithmetic operation result. In some embodiments, the data precision indicated by the rs is the same as the relatively high precision in the operands of the rs1 and the rs2. For example, the result of adding the int8 and the float16 is stored by the 16-bit floating-point register. In some embodiments, the precision indicated by the rs is higher than the relatively high precision in the operands of the rs1 and the rs2. For example, the result of multiplying the int8 and the float16 is stored by the 32-bit floating-point register.

For this instruction form, decoding unit 115 decodes, identifies an operation code op of the instruction, and the first register rs1, the second register rs2 and the third register rs corresponding to the first operand, the second operand and the result operand in register file 116, and transmits the decoding result to arithmetic logic unit 131. Arithmetic logic unit 131 executes corresponding operation.

In some other embodiments, the mixed precision operation instruction includes an operation code and only includes fields indicating the first register to the third register. That is, the instruction only indicates registers of two operands literally and does not indicate registers storing results, or the instruction only indicates registers of one operand and registers storing results literally and does not indicate registers of another operand, and in such condition, the decoding unit uses the registers determined to be not indicated and adds corresponding register identifiers to decoding information. For example, the decoding unit identifies a default register or a result register of a previous instruction as an unassigned register.

As an example, the instruction form of the mixed precision operation is:

$$op rs 1 , rs 2 ; \qquad ( 4 )$$

The instruction form does not include the register for storing the result. Therefore, the decoding information provided by the decoding unit indicates that an AV register stores the result, and the AV register is a default register in multiplication operation for example.

In addition, considering that the mixed precision operation instruction belongs to the extension instruction of the instruction set, a certain register in the instruction processing apparatus can be adopted to store an enabling identifier indicating whether the instruction or the extension instruction is allowed to be executed or not. Execution unit 111 determines whether to execute the instruction or the extension instruction or not according to the value of the enabling identifier. When the enabling identifier is indicated to indicate that the instruction or the extension instruction is not allowed, execution unit 111 does not execute the corresponding instruction and optionally generates abnormal information.

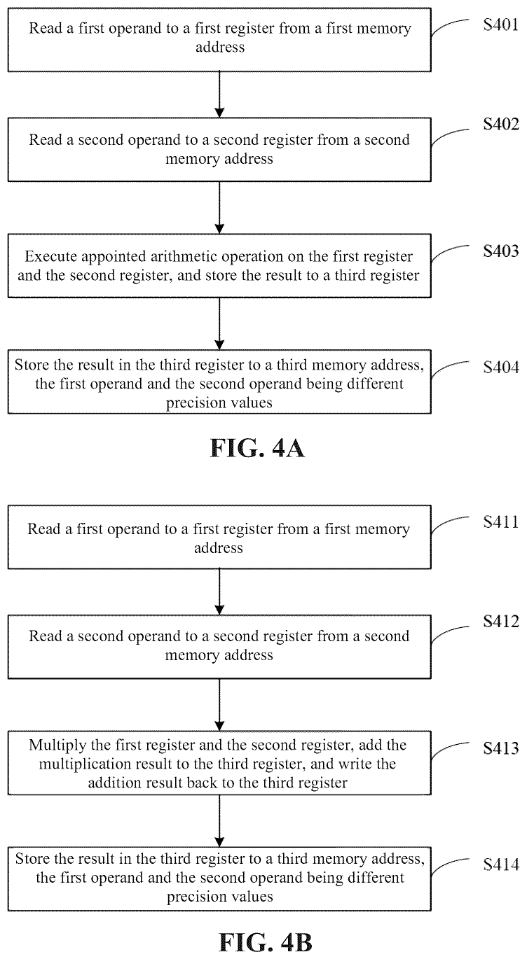

FIG. 4A and FIG. 4B are flowcharts of an exemplary processing method of mixed precision operation, according to some embodiments of the present disclosure. The mixed precision operation in FIG. 4A refers to one of addition, subtraction, multiplication and division, and the mixed precision operation in FIG. 4B refers to multiply accumulation. The processing methods in FIG. 4A and FIG. 4B can be both executed by a computer system (e.g., processor 100 in FIG. 2) that includes a processor and a storage. Computer instructions capable of being executed by the processor are stored in the storage; and the computer instructions are executed by the processor to implement the steps in FIG. 4A or FIG. 4B. As shown in FIG. 4A, the following steps are provided.

In step S401, the computer system reads a first operand to a first register from a first memory address.

In step S402, the computer system reads a second operand to a second register from a second memory address.

In step S403, the computer system executes appointed arithmetic operation on the first register and the second register, and stores the result to a third register.

In step S404, the computer system stores the result in the third register to a third memory address, wherein the first operand and the second operand are different precision values.

According to some embodiments, the processing procedure of the processor in the computer system on the mixed precision operation includes: reading a first operand of the mixed precision operation to the first register from the appointed data cache, reading a second operand to the second register from the appointed data cache, performing appointed arithmetic operation on the two registers, storing the result to the third register, and finally storing the result in the third register into the appointed data cache, the first operand and the second operand being different precision values.

In some embodiments, steps S411-S413 that are executed repeatedly and S414 are shown in FIG. 4B.

In step S411, the computer system reads a first operand to a first register from a first memory address.

In step S412, the computer system reads a second operand to a second register from a second memory address.

In step S413, the computer system multiplies the first register and the second register, adds the multiplication result to the third register, and writes the addition result back to the third register.

In step S414, the computer system stores the result in the third register to a third memory address, wherein the first operand and the second operand can be with different precision values.

According to some embodiments, the processing procedure of the processor in the computer system on multiply accumulation includes: reading a first operand of the mixed precision operation to the first register from the appointed data cache, reading a second operand to the second register from the appointed data cache, then multiplying the first register and the second register, adding the multiplication result to the third register, writing the addition result back to the third register, and finally storing the result in the third register into the appointed data cache The first operand and the second operand can be with different precision values. A cycle formed by steps S411 to S413 can be repeatedly executed for multiple times. For example, for abovementioned z1=x1w1+x2w3, steps S411 to S413, which forms a cycle, can be executed twice. After the first cycle is finished, x1w1+z1=z1 (initial z1=0) is computed. z1+x2w3=z1 can be computed in the second cycle, and so on.

It is to be understood that the processor in the computer system completes one time of mixed precision operation through the four steps above on the premise that the instruction set architecture embedded in the processor needs to support arithmetic operation of operands with different precisions. In order to achieve this objective, for some processor architectures which do not support the arithmetic operation, an extension instruction, namely a mixed precision operation instruction, needs to be added in thee instruction set. Particularly, for RISC-V processor architectures which do not support the arithmetic operation, the mixed precision operation instruction is added to serve as the extension instruction.

Further, a circuit for arithmetic operation in an existing processor architecture can execute arithmetic operation with different precisions or can execute arithmetic operation with different precisions only through fine adjustment, so the implementation difficulty of some embodiments of the present disclosure is not high. With the increasing application of mixed precision models, it also reflects more practical value and economic value. For example, the weight range of an automatic voice recognition model is relatively concentrated, while the distribution range of the input data is large, so the automatic voice recognition model can be implemented as a mixed precision model with the weight parameter of int8 and the input data of float16. The instruction processing apparatus according to some embodiments of the present disclosure can improve the execution efficiency of voice-related projects adopting the automatic voice recognition model.

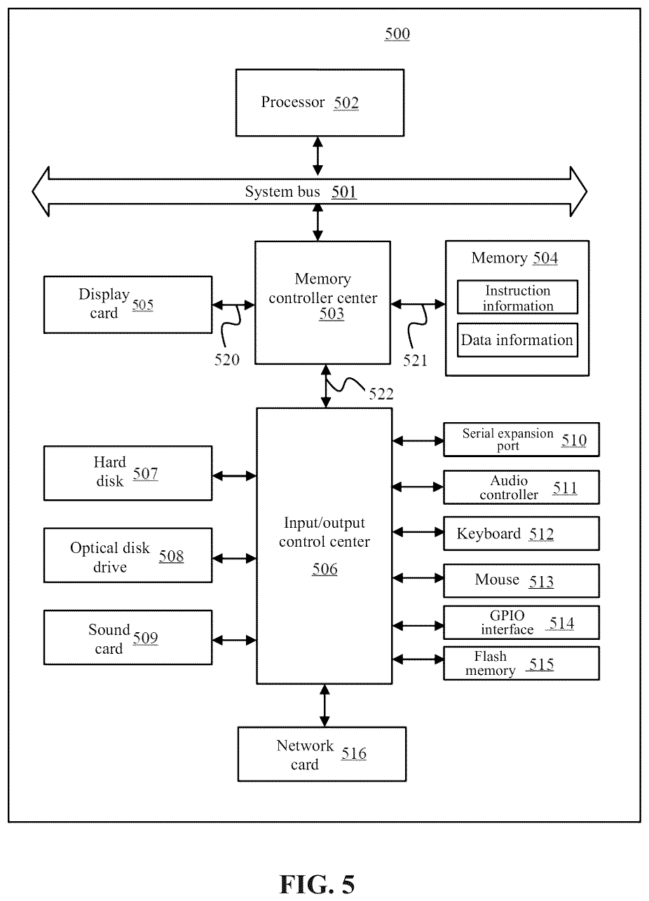

FIG. 5 is a structural schematic diagram of an exemplary processing system 500 according to some embodiments of the present disclosure. As shown in FIG. 5, system 500 (e.g., a computer system) is an example of a “central” system architecture. System 500 can be constructed based on various types of processors in the current market and is driven by operating systems such as WINDOWS™ operating system versions, UNIX operating systems and Linux operating systems. In addition, system 500 can be generally implemented in a PC, a desktop computer, a notebook computer or a server.

As shown in FIG. 5, system 500 includes a processor 502. Processor 502 has the data processing capacity. For example, processor 502 may be a processor of a CISC architecture, an RISC architecture and a VLIW architecture, or a processor for achieving the instruction set combination, or any processor device constructed for a special target.

Processor 502 is connected to a system bus 501, and system bus 501 may transmit data signals between processor 502 and other components. Processor 502 may be processor 100 shown in FIG. 2 or instruction processing apparatus 210 shown in FIG. 3, or a variant of the above processing unit.

System 500 further includes a memory 504 and a display card 505 (may also referred to as a graphic card). Memory 504 may be a Dynamic Random Access Memory (DRAM) device, a Static Random Access Memory (SRAM) device, a flash memory device or other memory devices. Memory 504 may store instruction information or data information represented by the data signals. Display card 505 may include a display driver and is configured to control correct display of display signals on a display screen.

Display card 505 and memory 504 are connected to system bus 501 through a memory controller center 503. Processor 502 may be in communication with memory controller center 503 through system bus 501. Memory controller center 503 provides a high-bandwidth memory access path 521 for memory 504 and is configured to store and read the instruction information and the data information. Meanwhile, memory controller center 503 and display card 505 transmit the display signals based on a display card signal input/output interface 520. The display card signal input/output interface 520 is of the interface type such as DVI and HDMI.

Memory controller center 503 transmits digital signals among processor 502, memory 503 and display card 505, and bridges among system bus 501, memory 504 and an input/output control center 506 for digital signals.

System 500 further includes input/output control center 506 which is connected to memory controller center 503 through a special hub interface bus 522, and some I/O devices are connected to input/output control center 506 through a local I/O bus. The local I/O bus is configured to connect peripheral devices to input/output control center 506 and then connected to memory controller center 503 and system bus 501. The peripheral devices include but are not limited to a hard disk 507, an optical disk drive 508, a sound card 509, a serial expansion port 510, an audio controller 511, a keyboard 512, a mouse 513, a GPIO interface 514, a flash memory 515 and a network card 516.

Definitely, the structure diagrams of different computer systems are changed according to different main board, operation system and instruction set architectures. For example, at present, memory controller center 503 is integrated into processor 502 through many computer systems, and therefore input/output control center 506 can become a control center connected to processor 503.

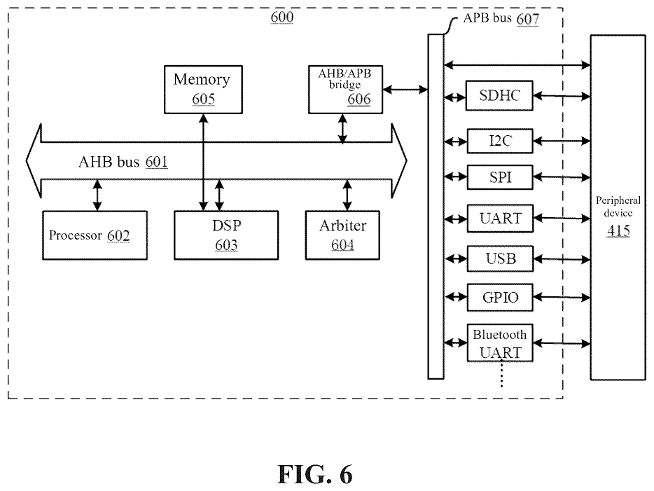

FIG. 6 is a structural schematic diagram of an exemplary processing system, according to some embodiments of the present disclosure. As shown in FIG. 6, system 600 (e.g., a system on chip, or simplified as SoC) may be formed by various types of processors in the current market. It may be driven by operating systems such as WINDOWS™ operating system versions, UNIX operating systems, Linux operating systems and Android operating systems. In addition, processing system 600 may be implemented in handheld devices and embedded products. Some examples of the handheld devices include a cellular phone, an internet protocol device, a digital camera, a Personal Digital Assistant (PDA) and a handheld PC. The embedded products may include a network computer (NetPC), a set-top box, a network hub, a Wide Area Network (WAN) switch, or any other system capable of executing one or more instructions.

As shown in FIG. 6, system 600 includes a processor 602, a Digital Signal Processor (DSP) 603, an arbiter 604, a memory 605 and an AHB (Advanced High performance Bus)/APB (Advanced Peripheral Bus) bridge 606 which are connected through an AHB (Advanced High performance Bus) 601. Processor 602 and DSP 603 may be processor 100 shown in FIG. 2 or instruction processing apparatus 210 shown in FIG. 3, or variants of the processing units above.

Processor 602 may be a Complex Instruction Set Computing (CISC) microprocessor, a Reduced Instruction Set Computing (RISC) microprocessor, a Very Long Instruction Word (VLIW) microprocessor, a microprocessor for realizing the combination of the instruction sets above, or any other processor devices.

AHB bus 601 can be configured to transmit digital signals among high-performance modules of system 600. For example, AHB bus 601 can be configured to transmit digital signals among processor 602, DSP 603, arbiter 604, memory 605 and AHB/APB bridge 606.

Memory 605 can be configured to store the instruction information or data information represented by digital signals. Memory 605 may be a Dynamic Random Access Memory (DRAM) device, a Static Random Access Memory (SRAM) device, a flash memory device or other memory devices. The DSP may access memory 605 through or not through AHB bus 601.

Arbiter 604 can be configured to be responsible for access control of processor 602 and DSP 603 to AHB bus 601. Because processor 602 and DSP 603 can control other components through the AHB bus, arbiter 604 is needed for confirmation at the moment.

AHB/APB bridge 606 can be configured to bridge data transmission between AHB bus 601 and an APB bus 607, specifically, by latching addresses, data and control signals from the AHB bus and providing second-level decoding to generate selection signals of APB peripheral devices, conversion from an AHB protocol to an APB protocol is achieved.

Processing system 600 may further include various interfaces connected with the APB Bus. Various interfaces include but are not limited to the following interface types: a Secure Digital High Capacity (SDHC), an I²C Bus, a Serial Peripheral Interface (SPI), a Universal Asynchronous Receiver/Transmitter (UART), a Universal Serial Bus (USB), a General-purpose input/output (GPIO) and a Bluetooth UART. A peripheral device 415 connected to the interfaces includes a USB device, a memory card, a message transceiver, a Bluetooth device and the like.

In addition, the processing method according to some of the above embodiments may be realized in the form of one or more computer readable media, and the computer readable media includes computer instructions which can be executed by the processing system or the instruction processing apparatus. In some embodiments, the computer instructions refer to instructions of a certain computer programming language such as an assembly language. The computer readable media may be a computer readable signal medium or a computer readable storage medium. The computer readable signal medium may include a data signal which is propagated in a baseband or as a part of a chopping wave, and computer readable program codes are carried; and the propagated data signal may be of various forms, including but not limited to an electromagnetic signal, an optical signal or any other suitable combination. The computer readable storage medium is, for example, but not limited to, an electric, magnetic, optical, electromagnetic, infrared or semiconductor system, apparatus or device, or any other combination thereof. More specific examples of the computer readable storage medium include: a portable computer magnetic disk, a hard disk, a Random Access Memory (RAM), a read-only memory (ROM), an erasable programmable read-only memory (EPROM or flash memory), an optical fiber, a portable compact disk read-only memory (CD-ROM), an optical memory, a magnetic memory or any other suitable combination thereof, which are electrically connected by one or more leads.

It is to be understood that the identical or similar parts of some embodiments in this specification can refer to other embodiments, and some embodiments focuses on the differences from other embodiments. In particular, for some of the method embodiments, because it is basically similar to the method described in the device and system embodiments, the description is relatively simple, and the relevant parts can be described in part of the other embodiments.

It should be understood that specific embodiments of the present specification are described above. Other embodiments fall within the scope of the appended claims. In some cases, actions or steps disclosed in the appended claims may be performed in a sequence different from the sequences in the embodiments and can still achieve the desired results. In addition, the processes depicted in the accompanying drawings do not necessarily require specific sequences or consecutive sequences to achieve an expected result. In some embodiments, multitasking and parallel processing may also be feasible or may be advantageous.

The embodiments may further be described using the following clauses:
1. An instruction processing apparatus, including:
a register file including a plurality of registers;
a decoding unit including circuitry configured to decode a mixed precision operation instruction and to acquire decoding information, the decoding information indicating an execution unit to execute following operations; and
an execution unit communicatively coupled to the register file and decoding unit and includes circuitry configured to acquire the decoding information from the decoding unit for executing operations including: executing appointed arithmetic operation on a first register and a second register of the plurality of registers, and writing an operation result back to a third register of the plurality of registers, precisions of operands of the first register and the second register being different.
2. The instruction processing apparatus according to clause 1, wherein the mixed precision operation instruction includes an operation code and at least one operand; and the at least one operand is used for indicating at least one of the first register, the second register and the third register.
3. The instruction processing apparatus according to clause 2, wherein in response to the at least one operand not indicating the first register, the second register and the third register simultaneously, the decoding unit includes circuitry configured to determine a target register that is not indicated in the at least one operand, and add a corresponding register identifier of the target register into the decoding information.
4. The instruction processing apparatus according to any of clauses 1 to 3, wherein the appointed arithmetic operation is multiplication, addition, subtraction or division.
5. The instruction processing apparatus according to any of clauses 1 to 4, wherein in response to the appointed arithmetic operation being multiply accumulation, the decoding unit includes circuitry configured to indicate the execution unit to execute the following operations: multiplying values stored in the first register and the second register, adding a multiplication result to a value stored in the third register, and writing an addition result back to the third register.
6. The instruction processing apparatus according to according to any of clauses 1 to 5, wherein the precision indicated by the third register is the same as the higher precision in operands in the first register and the second register, or higher than the higher precision in the operands in the first register and the second register.
7. The instruction processing apparatus according to according to any of clauses 1 to 6, wherein the first register is an 8-bit integer register, and the second register is an 8, 16, 19, 32 or 64-bit floating-point register.
8. The instruction processing apparatus according to according to any of clauses 1 to 7, wherein an instruction set architecture of the instruction processing apparatus is an RISC-V instruction set architecture.
9. The instruction processing apparatus according to clause 8, wherein the mixed precision operation instruction is an extended instruction of the RISC-V instruction set architecture.
10. A processing method of mixed precision operation, including:
reading a first operand to a first register from a first memory address;
reading a second operand to a second register from a second memory address;
executing appointed arithmetic operation on the first register and the second register, and storing an operation result to a third register; and
storing the operation result in the third register to a third memory address, the first operand and the second operand being different precision values.
11. The processing method according to clause 10, wherein the precision indicated by the third register is the same as the higher precision in operands in the first register and the second register, or higher than the higher precision in the operands in the first register and the second register.
12. The processing method according to clause 10 or 11, wherein each operation of the processing method corresponds to an assembly instruction.
13. A processing method of mixed precision operation, the mixed precision operation is multiply accumulation, the processing method including:
performing the following a plurality of times:
   reading a first operand to a first register from a first memory address;
   reading a second operand from a second memory address to a second register; and
   multiplying the first register by the second register by a multiply accumulation circuit, adding a multiplication result to a third register, and writing an addition result back to the third register, the first operand and the second operand being different precision values; and
storing a result in the third register to a third memory address.
14. A computer system, including:
a memory; and
one or more processors communicatively coupled with the memory, the memory storing a set of instructions that are executable by one or more processors of the computer system to cause the computer system to perform operations according to any of clauses 10 to 12.
15. A non-transitory computer readable medium, storing a set of instructions that are executable by one or more processors of a device to cause the device to perform operations, including:
reading a first operand to a first register from a first memory address;
reading a second operand to a second register from a second memory address;
executing appointed arithmetic operation on the first register and the second register, and storing an operation result to a third register; and
storing the operation result in the third register to a third memory address, the first operand and the second operand being different precision values.
16. The non-transitory computer readable medium according to clause 15, wherein the precision indicated by the third register is the same as the higher precision in operands in the first register and the second register, or higher than the higher precision in the operands in the first register and the second register.
17. The non-transitory computer readable medium according to clause 15 or 16, wherein each operation corresponds to an assembly instruction.

As used herein, spatial relative terms “under”, “below”, “underneath”, “above”, “on” and “over” and similar terms describe the relationship between an assembly or component and a remote assembly or component illustrated in the figures. In addition to the orientation described in the figures, the spatial relative terms also aim to cover different orientations of an apparatus in use or operation. A device may be oriented in other ways (by rotating 90 degrees or by other orientations), and therefore, spatial relative descriptors used herein can also be explained.

As used herein, unless specifically stated otherwise, the term “or” encompasses all possible combinations, except where infeasible. For example, if it is stated that a component may include A or B, then, unless specifically stated otherwise or infeasible, the component may include A, or B, or A and B. As a second example, if it is stated that a component may include A, B, or C, then, unless specifically stated otherwise or infeasible, the component may include A, or B, or C, or A and B, or A and C, or B and C, or A and B and C.

As used herein, terms such as “first”, “second” and “third” describe various assemblies, components, regions, layers and/or sections, but such assemblies, components, regions, layers and/or sections should not be restricted by such terms. This type of terms can only be used for distinguishing one assembly, component, region, layer or section from each other. For example, the terms such as “first”, “second” and “third” when used herein do not imply a sequence or an order, unless explicitly indicated by the background content.

The singular forms “a/an”, “one” and “the” may also include a plural form, unless otherwise specified by the context. The term “connection” and derivatives thereof can be used herein to describe the structural relationship between components. The “connection” can be used for describing two or more assemblies that are in direct physical or electrical contact with each other. The “connection” can also be used for indicating direct or indirect physical or electrical contact between two or more assemblies (with intervening assemblies between them), and/or the cooperation or interaction between the two or more assemblies.

The foregoing descriptions are merely preferred implementations of the present disclosure. It is to be noted that a plurality of improvements and refinements may be made by those of ordinary skill in the technical field without departing from the principle of the present disclosure, and shall fall within the scope of protection of the present disclosure.

In the drawings and specification, there have been disclosed exemplary embodiments. However, many variations and modifications can be made to these embodiments. Accordingly, although specific terms are employed, they are used in a generic and descriptive sense only and not for purposes of limitation.

What is claimed is:

1. An instruction processing apparatus, comprising:
a register file comprising a plurality of registers;
a decoding unit including circuitry configured to decode a mixed precision operation instruction and to acquire decoding information, the decoding information indicating an execution unit to execute following operations; and
an execution unit communicatively coupled to the register file and decoding unit and includes circuitry configured to acquire the decoding information from the decoding unit for executing operations comprising: executing appointed arithmetic operation on a first register and a second register of the plurality of registers, and writing an operation result back to a third register of the plurality of registers, precisions of operands of the first register and the second register being different.

2. The instruction processing apparatus according to claim 1, wherein the mixed precision operation instruction comprises an operation code and at least one operand; and the at least one operand is used for indicating at least one of the first register, the second register and the third register.

3. The instruction processing apparatus according to claim 2, wherein in response to the at least one operand not indicating the first register, the second register and the third register simultaneously, the decoding unit includes circuitry configured to determine a target register that is not indicated in the at least one operand, and add a corresponding register identifier of the target register into the decoding information.

4. The instruction processing apparatus according to claim 1, wherein the appointed arithmetic operation is multiplication, addition, subtraction or division.

5. The instruction processing apparatus according to claim 1, wherein in response to the appointed arithmetic operation being multiply accumulation, the decoding unit includes circuitry configured to indicate the execution unit to execute the following operations: multiplying values stored in the first register and the second register, adding a multiplication result to a value stored in the third register, and writing an addition result back to the third register.

6. The instruction processing apparatus according to claim 1, wherein the precision indicated by the third register is the same as the higher precision in operands in the first register and the second register, or higher than the higher precision in the operands in the first register and the second register.

7. The instruction processing apparatus according to claim 1, wherein the first register is an 8-bit integer register, and the second register is an 8, 16, 19, 32 or 64-bit floating-point register.

8. The instruction processing apparatus according to claim 1, wherein an instruction set architecture of the instruction processing apparatus is an RISC-V instruction set architecture.

9. The instruction processing apparatus according to claim 8, wherein the mixed precision operation instruction is an extended instruction of the RISC-V instruction set architecture.

10. A processing method of mixed precision operation, comprising:
reading a first operand to a first register from a first memory address;
reading a second operand to a second register from a second memory address;
executing appointed arithmetic operation on the first register and the second register, and storing an operation result to a third register; and
storing the operation result in the third register to a third memory address, the first operand and the second operand being different precision values.

11. The processing method according to claim 10, wherein the precision indicated by the third register is the same as the higher precision in operands in the first register and the second register, or higher than the higher precision in the operands in the first register and the second register.

12. The processing method according to claim 10, wherein each operation of the processing method corresponds to an assembly instruction.

13. A non-transitory computer readable medium, storing a set of instructions that are executable by one or more processors of a device to cause the device to perform operations, comprising:
reading a first operand to a first register from a first memory address;
reading a second operand to a second register from a second memory address;
executing appointed arithmetic operation on the first register and the second register, and storing an operation result to a third register; and
storing the operation result in the third register to a third memory address, the first operand and the second operand being different precision values.

14. The non-transitory computer readable medium according to claim 13, wherein the precision indicated by the third register is the same as the higher precision in operands in the first register and the second register, or higher than the higher precision in the operands in the first register and the second register.

15. The non-transitory computer readable medium according to claim 13, wherein each operation corresponds to an assembly instruction.
